(19) United States
(12) Patent Application Publication
(10) Pub. No.: US 2011/0082969 A1
(43) Pub. Date: Apr. 7, 2011

(54) Associative data storage devices for authentication of collectable objects

(76) Inventor: James Joseph Macor, Jackson, NJ (US)

(21) Appl. No.: 12/928,280

(22) Filed: Dec. 8, 2010

Related U.S. Application Data
(63) Continuation-in-part of application No. 12/924,170, filed on Sep. 22, 2010.
Application No. 12/924,170 is a continuation-in-part of application No. 12/156,186, filed on May 30, 2008.
Application No. 12/156,186 is a continuation-in-part of application No. 12/072,618, filed on Feb. 27, 2008, now abandoned.
Application No. 12/072,618 is a continuation-in-part of application No. 11/710,378, filed on Feb. 23, 2007.
Application No. 11/710,378 is a continuation-in-part of application No. 11/891,407, filed on Aug. 10, 2007.
Application No. 11/891,407 is a continuation-in-part of application No. 11/513,004, filed on Aug. 30, 2006.
Application No. 11/513,004 is a continuation-in-part of application No. 11/493,312, filed on Jul. 26, 2006.

(51) Int. Cl. G06F 12/00; B65D 85/00

(52) U.S. Cl. 711/103; 206/459.5; 711/E12.001

(57) ABSTRACT

In one embodiment of the present invention, an associative data storage device for authentication of collectable objects is described. A non-volatile electronic data storage device is used in combination with at least one collectable object. The non-volatile electronic data storage device is detached from the collectable object and electronically configured to store at least one immutable digital image of at least one unique appearance characteristic of the collectable object. The data storage device is provided with tamper resistant visual markings that are associative with visual markings of the collectable object so as to provide association of the data storage device with the collectable object. The non-volatile electronic data storage device is compatible with a standard computer system for a user to view one or more digital images of the unique appearance characteristics of the collectable object for authentication and identification of the collectable object. In preferred embodiments, the non-volatile data storage device is a solid-state Flash Memory type data storage device.

### REFERENCES TO RELATED APPLICATIONS

This application relates to and is a continuation-in-part of the following co-pending U.S. patent applications, all of which have been filed by the inventor herein: U.S. Application 12924170, filed on Sep. 22, 2010, entitled “Protection, authentication, identification device for a physical object specimen,” U.S. Application 12156186, filed on May 30, 2008, entitled “Authentication and identification device for a collectable object,” U.S. Application 12072618 (ABN), Feb. 27, 2008 Protection and authentication device for a collectable object,” U.S. Application 11710378, Feb. 23, 2007, entitled “Protection and authentication device for trading collectable objects,” U.S. Application 11891407, filed Aug. 10, 2007, entitled “Collectable display panel and data storage device,” U.S. Application 11513004, filed Aug. 30, 2006, entitled “Associative data storage system for collectable objects,” U.S. Application 11493312, filed on Jul. 26, 2006, entitled “Protection, authentication, identification device for a collectable object”

### BACKGROUND OF INVENTION

Small collectable objects such as coins, stamps, sports cards, etc. have been preserved, collected and traded by individuals for as long as collectable objects have existed. Collectable objects, such as coins, have further benefited more recently from grading and certification service organizations that certify a collectable and place the collectable in a tamper resistant holder for protection, preservation and authentication.

Professional collectables certification organizations, such as the Professional Coin Grading Service (PCGS) authenticate, identify, and certify authenticity of collectable objects using certain unique detailed appearance characteristics, which vary from object to object. It is an important objective of the present invention that it may provide visual identification and authentication of a collectable object by providing a means for easily accessing and comparing detailed digital image/s of the unique appearance characteristics of a collectable object. Such unique appearance characteristics of a collectable coin may include, for example, strike, luster, reflectance, color, defects, abrasions, centering, reeding characteristics (edge characteristics), die-varieties, toning, etc. The present invention provides a more robust authentication device for certified collectables, a symbiotic enhancement to professional certification services organizations, and would help deter a growing problem of counterfeit of collectables in the marketplace.

It is another an important objective of the present invention that it provides for a collector to store the actual collectable object in a holder for preservation, and also use (in combination) an “associative” data storage device that is “detached” from the collectable object, and being connectable and operational in a detached condition from the collectable object, and with only the need of a standard computer. The detached (associative) data storage device is configured to record and store at least one immutable digital picture image of at least one unique appearance characteristic of the collectable object for authentication and identification of the collectable object. There are many benefits provided by the present invention device by having a “detached” data storage device that stores detailed digital images of the unique appearance characteristics of the collectable object, and other possible data, such as historical information, in a detached condition from the collectable. For instance, a collector may store a valuable coin in a bank safety deposit box, for enhanced security and protected storage. The associative data storage device (with associative visual markings of the same collectable) serves as a “detached authentication record of that collectable.” As such, the device may be utilized by a collector (anytime and anywhere) to view detailed authentication picture image/s of the collectable with only the need for a standard computer, such as a laptop computer. The authentication and identification image record/s provide important benefits, for instance, the associative data storage device may be used for insurance verification, records documentation, and authentication certification should the collector or user decide to sell the collectable.

It is yet another important objective of the present invention that any images and data can be viewed by means of a standard computer, without the need of costly extraneous equipment (e.g., RFID readers and scanners) and without the requirement for Internet online operability. As such, the present invention teaches a low-cost invention device that eliminates the need for costly extraneous devices, transmitters, readers, scanners, equipment, etc. The present invention device is designed and structured to operate as a low-cost, easy to use device for a common collector, and with only the need for a standard computer.

It is yet another important objective of the present invention that the data storage device, such as a flash memory device, is a “non-volatile” type data storage device (being well known in the industry as without the need for an on-board battery or power source). As the data storage device and authentication record of the unique appearance characteristics of the collectable may be stored for many years, it is an objective of the present that it may be stored without concern of replacing a battery, or the potential adverse effects that may occur, over time, by any adverse chemical reactions that may occur as the result of any attached battery powered component.

It is yet another important objective of the present invention to provide for a long-term digital record of digital picture images of the unique appearance characteristics related to the collectable. This is accomplished by configuring the data storage device to have an immutable condition (resistant to change or alteration) at least in part, or as a whole. As such, the data storage device may be configured in part (a configured electronic partition) with a Read-Only-Memory (ROM), or as a whole, such as a Write-Once-Read-Many (WORM) device that is configured during the write cycle.

In preferred embodiments, it is yet another important objective of the present invention that digital picture image records of the unique appearance characteristics of the collectable object can be viewed by a standard computer, and without the need for online-Internet operability. In addition to increased cost for Internet service, at times, depending on equipment, service, and location, Internet online operability may not be available or reliable. Remote storage of digital data or images, are potentially susceptible to all kinds of adverse conditions, malfunctions, and failures that are not “controllable” by the owner of the stored data. Unlike the present invention, remotely stored data and any images, e.g., stored on a host computer or remote server, are susceptible to, for example, software and hardware failures, software viruses, theft, alterations of data or images, telecommunications failure (even temporarily), equipment failures, power failures (even temporarily), environmental calamities (floods and fire), business failures (website closures) (e.g., bankruptcies). Such examples of remote database failures are certainly plausible over time, are not controllable by the owner of the collectable object in hand, and could create an “interim or permanent failure” for the user to view any data, records, or images at all. The present invention overcomes the aforesaid deficiencies of remote storage of any data or images, and eliminates any requirement or operational devices needed for online Internet operability.

### DESCRIPTION OF RELATED ART

The following references may be related, at least in part, or to portions of the present invention:

U.S. Patent Application 20070113451 to McDowell describes a collectible holder that is that is fabricated from three portions—a sleeve portion, an insert portion, and a collectible receivable portion. The collectible receivable portion is insertable into, and removable from, an aperture located in the insert portion. The insert portion is inserted into the sleeve portion and sonically bonded. A Radio Frequency IDentification (RFID) tag is also provided in the collectible holder to store information associated with the stored collectible. As multiple RFIDs can be read simultaneously, numerous features are provided. In one, a scanner is presented at the unloading dock of a convention. A dealer is provided with a time to go through the scanner. All of the dealer's collectibles are uploaded to a remote database, an online store is autonomously generated for the collectibles, and the inventory published to the internet as part of an online inventory of the entire convention.

U.S. Patent Application 20040039663 to Kemz describes a method and a system facilitating trade in graded encapsulated commoditized objects such as coins includes a marketplace computer operatively controlled by an online peer-to-peer trade enabling facility and storing data associated with offers to sell and offers to buy the objects being selected from a plurality of graded encapsulated objects provided by at least one third party grading firm. A host computer operatively controlled by a market maker engaged in the trade of the graded encapsulated commoditized objects stores relevant trade data associated with the objects. The Internet can be used to connect the computers and to connect sellers and buyers with the marketplace computer whereby the sellers and the buyers are provided access to the relevant trade data stored in the host computer.

U.S. Pat. No. 6,501,390 to Chainer provides methods and apparatus to detect and reliably record the physical history of a product including effects due to one or more of the following: 1) product use 2) handling 3) tampering and 4) environment of the product (as changes in the environment, such as excessive temperatures, humidity, or shocks, can result in degradation to a product). The apparatus includes a “smart card”, or, more generally, “smart token”, in combination with one or more sensors which record the external influences on the product and/or the environment and records those changes in an encrypted form. This information can then be verified by any individual who is equipped with a (possibly public) decryption key, but capability to modify this information, depending on the application, is restricted to those with access to the encrypting key. Furthermore, the apparatus contains authentication information which can be reliably verified, in particular to confirm that the apparatus is attached to the product it supposed to be attached to.

U.S. Pat. No. 5,042,650 to Mayer describes a tamperproof coin case defined by two interlocking plastic plate members ultrasonically bonded together to define a unitary assembly within which a coin and its certificate of authenticity may be permanently secured. One plate member includes a cavity for fully receiving the other plate member therein, with opposing inner surfaces of the plate members being provided with corresponding cylindrical recesses which collectively form a cylindrical cavity within which a pliable plastic retention ring is disposed for securing the coin in a stationary position and permitting its obverse and reverse sides to be viewed through dome-shaped windows provided on the opposite sides of the case. The case is also provided with outwardly extending circumferential flanges which permit a plurality of cases to be vertically stacked for transport or storage.

U.S. Patent Application Publication No. 20030220885 to Lucarelli describes an on-line system for authenticating a collectible item or other type of memorabilia is provided which includes a web page on a on-line title company's website for the collectible item, wherein the web page displays a digital image of the collectible item, written description of the item, and the current owner of the collectible item. The web page is assigned a unique URL address and unique password. The web page may be viewed by the general public via the internet through the URL address in read only format. In the event of a transfer of ownership of the collectible item, the new owner is given the URL address for the web page, and the password. The new owner may then edit the owner information field on the web page by entering the password provided to him or her by the previous owner to update the owner's information displayed on the web page. In a further aspect of the invention, the collectible item is an individual video and audio segment of a celebrity reciting a greeting to an individual chosen from a selection of available greetings, which is saved on a VHS cassette or DVD, and may also be saved in a computer file and then displayed on a web page and viewed by the general public as set forth above.

U.S. Pat. No. 5,841,878 to Arnold describes a collectible article provides a multimedia representation of a desired subject. Such multimedia representation will include a visual representation of the subject appearing on at least a portion of the article. In addition to such visual media, an audible sound segment, reproducible and selectively activated as desired by an activation switch. The article is advantageously of compact, card-like format, and can be user personalized by permitting the recording, and selective playback, of a sound segment corresponding to the visually depicted image appearing on a portion thereof. The article may optionally include a space reserved for receiving an autograph. By carrying the article to places where there may be a likelihood of encountering the depicted celebrity, the owner will have same at hand for personalization by the figure. A spoken message to the presenting owner of the card-like article may there be recorded by the celebrity for long term storage and future playback, and/or the card signed in the appropriate location thereon. The article may further include displayed statistical information and the like disposed on an reverse side of the card, conveniently in the form of, for example, a liquid crystal alphanumeric display, or the like, which includes one or more rows. In a further embodiment, the above features are incorporated in a protective housing for display of existing trading cards and the like.

U.S. Patent Application No. 20070075861 to Cook describes an RFID tag configured to contain identification information in at least three forms. For instance, the RFID tag may include an RFID system, a human readable number and a bar code that may be visible on an outer surface of the body. The RFID system, the human readable number and the bar code may be adapted to generate the same asset identification number. The RFID tag may also be formed from two or more layers having a thickness sufficient to substantially eliminate interference caused by a shipping container to which the RFID tag is attached.

U.S. Patent Application No. 20030028494 to King describes a system and method for establishing and managing authenticated electronic documents (e.g. commercial contracts) whereby the content, revision status and authenticating parties are stored, tracked, retrieved and validated on demand by permitted users. Variable document data is input by user into an electronic form template and this data is captured by the system. The system derives a document number and revision number for the document and all of this identifying information is associated with the document and stored. A document digest formula is applied to generate a unique document digest. The system then generates a unique barcode for each page of the document based on the digest, document number, revision number and paging details and the barcodes are electronically added to the associated pages of the document. Either the parties to the document sign a printed copy of the barcoded document or a digital signature is applied using a third party validation service. The resultant signed and barcoded document is stored electronically whereby permitted users may locate existing documents (e.g. contracts), track document revisions and validate document contents and signatories.

U.S. Pat. No. 6,608,911 to Lofgren relates to digital watermarks integrated into holograms, watermarked hologram structures, and related applications as an authentication technique. One method creates a watermark image, and then embeds the watermark image into a holographic structure. The holographic structure is carried by a smart card. The smart card includes additional information. In one embodiment, the digital watermark includes information bits, and these information bits are used to authenticate the hologram, or the smart card. In another embodiment, the watermark's information bits are compared with the additional information carried by the smart card. The result of the comparison is used to authenticate the smart card or the hologram.

U.S. Patent Application No. 20050103840 to Boles describes an arrangement for certifying and checking gem stones and other valuables and comprises an electron microscope (11) controlled by a computer (1) and arranged to acquire digitised electron micrographs of characteristic regions of the gem stone or other valuable, particularly the culet (13) or girdle (14) which are typically highly irregular and therefore highly characteristic of individual stones. The digitised electron micrographs are encrypted and written to an RFID (7) which can be embedded in a plastics certificate (10) of in some cases a concealed on the valuable itself. Any tampering with the gem stone (12) or other valuable can be detected by reading the stored micrographs in the tag (7) and comparing them with micrographs newly acquired from the gem stone (12) or valuable as presented for verification. For extra security, the digitised encrypted micrographs are also stored in a remote database which can also include transaction data and can be linked to a credit card database of a financial institution.

U.S. Patent Application No. 20090284754 to Haddock describes a method to generate an optical signature of a coin is disclosed. A plurality of parameters are generated and recorded related to rotational positions around the circumference of a coin. The data from these parameters are combined to produce a searchable value.

U.S. Patent Application No. 20100046068 to Tafas describes a method and apparatus for automating microscopic analysis of a plurality of data-encoded microscope slides. In embodiments, the data written to or read from the slides may comprise images, analysis protocols, analytic results and other pertinent data. Embodiments also encompass a magazine that contains a plurality of data encoded slides.

It is believed that the present invention provides unique benefits that the related art cannot, for a “associative data storage device for authentication of collectable objects.” For example, U.S. Patent Application Publication No. 2007/0113451, to McDowell, et al., teaches the use of a holder using an RFID (Radio Frequency Identification Device) for storing a collectible identification number, a scanner for reading the RFID, a processor for looking up information associated with the collectable object, an external data storage for an online store, a website, and Internet operability for buyers and sellers to participate in trading of the collectable objects at the website store.

McDowell does not teach an “associative data storage device for authentication of collectable objects” having a “detached” non-volatile data storage device that operates in a detached condition for invention operation. Indeed, McDowell's RFID is not detachable from the sealed holder that also stores the collectable, e.g., coin, or the invention is rendered inoperable. Simply stated, if McDowell does not include at least one RFID in the sealed holder device, McDowell cannot scan the holders with an RFID scanner device to upload a list of collectables and create his online store for the sale of the collectables. Furthermore, McDowell, cannot provide the anti-theft, security based tracking feature for the RFID enabled collectable holders at a convention site as intended and described. Indeed, in the present invention, the non-volatile electronic data storage device is “detached” from the collectable object (or a holder that stores the collectable), and operates separately from the collectable with only the need for a standard computer, such as a laptop computer. Even though McDowell teaches the possibility of additional “add on” electronic devices, circuitry, batteries, or multiple RFIDs, McDowell must maintain “at least one RFID” with the collectable, in the same sealed holder, at all times, or McDowell's invention is simply inoperable.

McDowell does not teach a non-volatile electronic data storage device that stores at least one immutable digital picture image of at least one unique appearance characteristic of a collectable object. Factually, McDowell does not teach the storing of any digital picture images at all. McDowell only “arguably” stores any image data on his external data storage, external to the holder device itself, such as a host computer or remote database. McDowell's low capacity RFID tag is structurally incapable of storing “detailed digital picture images” of the unique “appearance characteristics” of the collectable object. Furthermore, any information or possible images (McDowell is silent here) stored by McDowell on the external database website would be considered both “volatile (changeable) and transitory (temporary)” data as McDowell has no need or motivation to store any data or images after a coin is sold.

Although McDowell provides the “possibility” of secondary electronic components, circuitry, and a battery, these additional invention elements only further distinguish and “teaches away” from the present invention in principle of operation, audience, and intended operation. For example, McDowell teaches a “possible scalable feature” with the addition of an LCD display (monitor) that may be coupled to the fundamental RFID device, and “possibly” the addition of additional RFIDs, additional memory, monitors, circuitry, and batteries (necessary for the monitor or LCD screen operation). In addition to adding cost, component and invention complexity, that which is opposed to the present invention's intended low cost and structural simplicity, the present invention is structurally distinguished again by its use of a “non-volatile” data storage device that expressly eliminates the need for a battery, or any on-board power source altogether, while maintaining desired structural invention simplicity, low cost, and functionality for storing digital picture image records of the collectable object. Indeed, the present invention eliminates the need for any on-board power source (e.g. batteries), monitors (e.g. LCDs), RFID devices, while retaining invention operation and functionality for a user to view detailed digital picture images the collectable for authentication and identification of the unique appearance characteristics of the collectable.

The present invention for a associative data storage device for authentication of collectable objects is further distinguished from McDowell by eliminating the need for storing any data or possible digital images via online server venues (websites), and thus eliminating any need for remote data storage, data processing and coding, and Internet operability, all of which are imperative to McDowell's invention operation and functionality. In addition to increased cost for Internet service, depending on equipment, service, and location, Internet online operability may not be available or reliable.

Unlike McDowell, the present invention includes a non-volatile electronic data storage device being capable and configured to store a least one immutable digital picture image of at least one unique appearance characteristic of the collectable, on the device itself, for use with a detached collectable object having associative visual markings of the data storage device. As such, the present invention eliminates the requirement for any online Internet access by a user, remote data stores, on-board power sources (e.g., batteries), built in display devices (e.g., LCDs), and any extraneous and costly reader devices (e.g., RFID readers). The present invention eliminates the structural component elements and equipment required for McDowell's costly and complex RFID tracking system and website store, while retaining invention functionality and intended use for a simple, easy to use, low cost authentication device for a common collector.

### SUMMARY OF THE INVENTION

In one embodiment of the present invention, an associative data storage device for authentication of collectable objects is described. A non-volatile electronic data storage device is used in combination with at least one collectable object. The non-volatile electronic data storage device is detached from the collectable object and electronically configured to store at least one immutable digital image of at least one unique appearance characteristic of the collectable object. The data storage device is provided with tamper resistant visual markings that are associative with visual markings of the collectable object so as to provide association of the data storage device with the collectable object. The non-volatile electronic data storage device is compatible with a standard computer system for a user to view one or more digital images of the unique appearance characteristics of the collectable object for authentication and identification of the collectable object. In preferred embodiments, the non-volatile data storage device is a solid-state Flash Memory type data storage device. The collectable object may have more than one characteristic associated with the collectable object, and the non-volatile electronic data storage device may include data of more than one characteristic of the collectable object.

The non-volatile electronic data storage device includes tamper resistant visual markings associative with a collectable object. A holder may be used to store the collectable object. The data storage device includes tamper resistant visual markings associative with the collectable object that are also associative with tamper resistant visual markings of a holder that houses the collectable object. The tamper resistant markings of the holder are associative with at least one corresponding tamper resistant visual marking of the non-volatile electronic data storage device, and may be or include a corresponding barcode.

In some embodiments, the non-volatile electronic data storage device may be detachably stored in a container having a formed cavity fitted for the data storage device, and, the collectable object is also detachably stored in the same container having a formed cavity fitted for storing the collectable object.

The non-volatile electronic data storage device may further comprise digital picture images of historical objects or persons related to the collectable object. In some embodiments, the non-volatile electronic data storage device may further comprise at least one immutable electronic link that fetches a predetermined remote database that stores information related to the collectable object. For security reasons, the electronic link may be encrypted.

### BRIEF DESCRIPTION OF DRAWINGS

FIG. 1 shows a top perspective view of a collectable object having visual markings for use in combination with a non-volatile electronic data storage device having tamper resistant visual markings (shown in FIG. 2) of the present invention.

FIG. 2 shows a top perspective view of a non-volatile electronic data storage device having tamper resistant visual markings for use in combination with a collectable object having visual markings (shown in FIG. 1) of the present invention.

FIG. 3 shows a right front perspective, exploded view of a holder for a collectable object including visual markings of the collectable object as used in the present invention.

FIG. 4 shows a right front perspective, exploded view of a data storage device including tamper resistant visual markings of an a collectable object as used in the present invention.

FIG. 5 shows a right front perspective view of an embodiment of the present invention including a collectable object having visual markings, housed in a holder having associative visual markings of the collectable object, and, a data storage device having associative visual markings of the holder that houses the collectable object.

FIG. 6 shows a right front perspective view of a present invention including a data storage device for use in combination with a collectable object (housed in a holder), detachably stored in a container having cavity openings fitted for storing the data storage device and the collectable object (shown in a holder), as used in the present invention.

FIG. 7 shows a diagram of a present invention device for use in combination with a collectable object and a standard computer system.

### DETAILED DESCRIPTION OF THE DRAWINGS

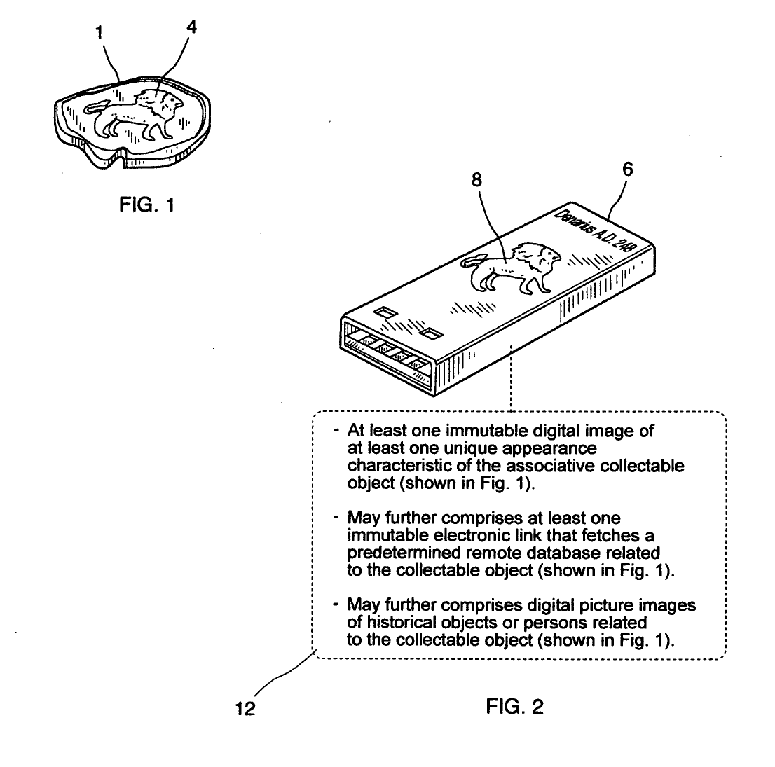

Referring now to the drawings which are for the purpose of illustrating preferred embodiments of the present invention and are not for the purpose of limiting same, FIG. 1 shows a top perspective view of a collectable object having visual markings for use in combination with a non-volatile electronic data storage device having tamper resistant visual markings (shown in FIG. 2) for use in the present invention. Other examples of small collectable objects may include, for example, stamps, currency, sports cards, etc., and would tend to benefit from a protective holder for preservation of such smaller type collectables. “Collectable” simply refers to an object having a trait of human interest to be collected. Collectable objects are typically purchased or acquired by a fancier for enjoyment, examination, and/or investment.

In FIG. 1, collectible coin 1 is an example of a collectable object for use in the present invention with a non-volatile electronic data storage device (shown in FIG. 2) for authentication and identification of the unique appearance characteristics of coin 1. Coin 1 may be for instance, an ancient Roman double Denarius struck in A.D. 248. Collectable objects, such as coin 1, possess “visual markings” typically formed from the striking of the coin's design elements that are engraved into a die-hub, and formed by a press that strikes the design into coin planchets (blank metal discs), or in ancient times even by hand. Visual markings of a coin may include, for example, dates of minting, inscriptions, denomination, country of origin, design elements (such as portraits of persons, animals, landmarks, events, and buildings), mintmarks, legends, etc. For instance, as illustrated on coin 1, there is visual marking 4 of a lion design element having a particular shape, scale, relief, and other identifiable characteristics. Furthermore, additional visual markings of coin 1 may include, for instance, its unique shape, reeding characteristics (edge of the coin), minute striking details, reflectance, luster patterns, abrasions, toning, coloration, and other visual markings that may be found on the opposite side (reverse) of coin 1 (not shown).

FIG. 2 shows a top perspective view of a non-volatile electronic data storage device 6 having tamper resistant visual markings 8 for use in combination with a collectable object having visual markings (shown in FIG. 1). Non-volatile electronic data storage device 6, may be a Flash Memory type data storage device, and well known for its non-volatile condition, or lack of an on-board power source, such as a battery. Non-volatile electronic data storage device 6 is used in combination with a collectable object, to provide an authentication record by identification of one or more unique appearance characteristics of the collectable object.

Non-volatile data storage device 6 is provided with tamper resistant visual markings associative with visual markings of at least one collectable object, such as coin 1 shown in FIG. 1. “Tamper resistant” means resistant to tampering or alteration. “Associative” means associated with or related to an element or characteristic of another. For example, visual marking 8 (lion design element) is associative with visual marking 4 (lion design element) as shown on coin 1, in FIG. 1. Although there are many different means and methods to provide tamper resistant visual markings, a permanent silk-screened vinyl ink application of visual markings 8 on the surface of data storage device 6, would be considered tamper resistant visual markings for use in the present invention.

Diagram 12, as shown in FIG. 2, is illustrative of the digital images and data that may be recorded on non-volatile electronic data storage device 6. Non-volatile electronic data storage device 6 is electronically configured to store at least one immutable digital image of at least one unique appearance characteristic of at least one collectable object. Non-volatile electronic data storage device 6 may further comprise digital picture images of objects and/or persons related to a collectable object, such as coin 1, shown in FIG. 1. In this example, non-volatile electronic data storage device 6 may include digital picture images related to coin 1 (shown in FIG. 1), such as a Double Denarius struck in A.D. 248 to commemorate the 1000^{th} anniversary of Rome's founding. Detailed digital picture images and historical facts may include, for example, digital picture images of the reining ruler, culture, dress, art, and other relevant historical information and images related to coin 1 (shown in FIG. 1) and recorded and stored on data storage device 6, shown in FIG. 2. Furthermore, non-volatile electronic data storage device 6 may comprise at least one immutable electronic link that fetches a predetermined remote database related to the collectable object. The database may include related information, related collectables for sale, valuation of the collectable, rarity populations of the collectable, and any other information of relevance.

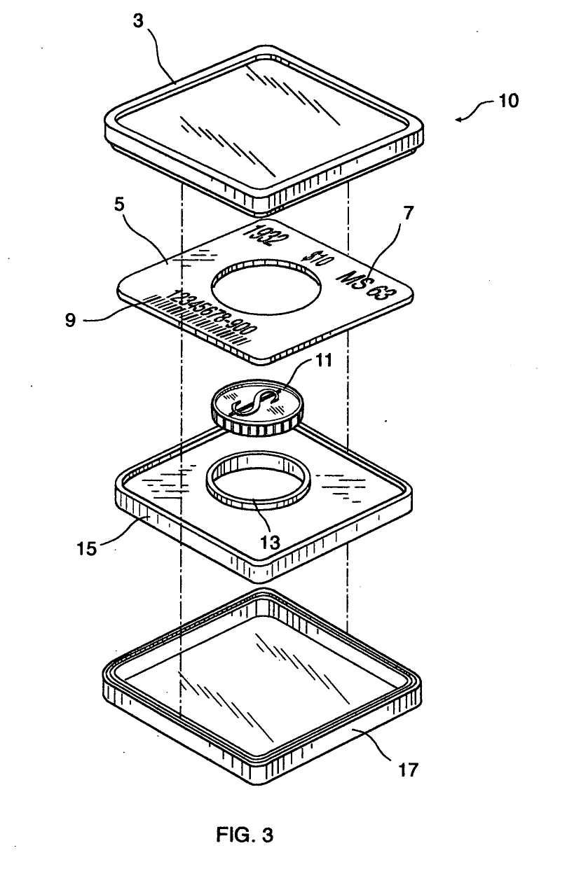

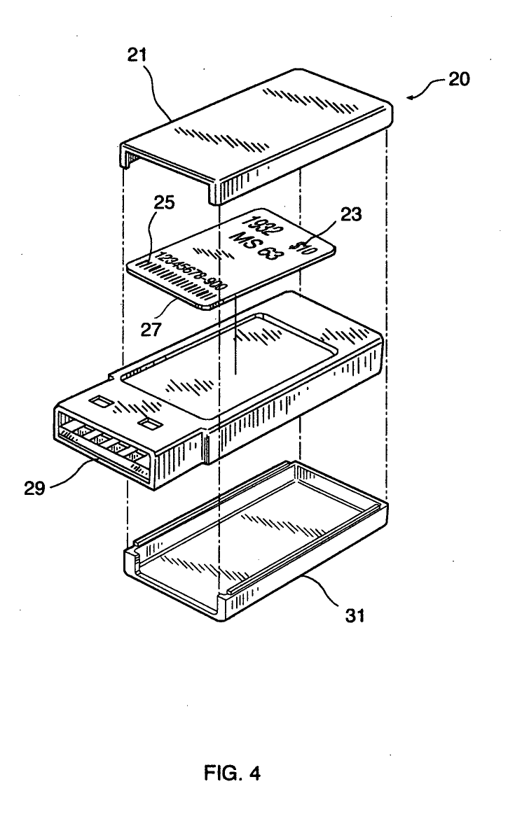

FIG. 3 shows a right front perspective, exploded view of a holder for a collectable object including visual markings of the collectable object as used in the present invention. Other small collectable objects of value and/or interest, such as stamps, currency, or sports cards are additional examples of collectable objects that would also be applicable to the present invention and would benefit from a protective holder for preservation of the collectable. Collectable objects, such as coin 11, possess visual markings, for example, and may have a date, a denomination, design elements, and other visual appearance characteristics. Coin 11 is shown having a visual marking “$” that may be related, for example, to the denomination of coin 11. Upon assembly, coin 11 is protected by holder 10 and comprised of upper housing 3 and lower housing 17, that may be made of a clear plastic material, such as an acrylic or polycarbonate material. Upper housing 3 and lower housing 17 may have a means to snap together, may be glued together, or may be ultrasonically bonded to further deter removal (detachment) of coin 11 from holder 10 upon assembly with holder 10. Also shown, is optional core component 15 that may be utilized to hold coin 11 in place by means of a friction fit, and coin 11 is simply inserted into core component opening 13 during the assembly process of coin 11 with the protective holder upper and lower housing parts. Core component 15 may be comprised of a plastic material, such as nylon, that retains coin 11 by means of a cut-through opening 13 and allows viewing of the front (obverse) and rear (reverse) of coin 11. Alternately, and within the scope of the present invention, core component 15 may be eliminated if holder 10 includes a formed recess or well in upper housing 3 or lower housing 17 that provides a substantial friction fit to retain coin 11, and thereby substantially reducing movement of coin 11 inside holder 10 upon assembly. Still again, a protective holder may simply be a clamshell type holder that is round in shape, and includes an upper and lower housing that are substantially formed just slightly larger than the width and height of coin 11, and may be pressed together to house coin 11. Plastic holder 10 that houses coin 11 after assembly, may include label 5 with visual markings and descriptors 7 of coin 11. For instance coin 11 may be a 1932 Indian $10 gold coin, and visual markings 7 may include, for example the date, the denomination, and a condition grade. As such, upon assembly of holder 10 with collectable object 11, label 5 provides tamper resistant visual markings that are associative with visual markings of coin 11. Visual markings 9 may simply be a corresponding barcode related to visual markings 7, and associative with the tamper resistant visual markings 23 of a non-volatile electronic data storage device as shown in FIG. 4.

Within the scope of the present invention, a collectable object is not required to be placed in a protective holder. For smaller collectables, such as coins, stamps, sports cards, and the like, a holder can provide an inexpensive means for protection and preservation of the collectable. However, as is the case with larger collectables, including collectable automobiles, artwork, antiques, and the like, such larger collectables cannot be practically housed in a protective holder, however, the present invention is also applicable to larger collectible objects. Larger collectable objects, such as a limited production automobile, also possess visual markings and unique appearance characteristics. For instance, a collectable automobile may have visual markings that include, for example, a manufacturer's identification tag, typically a stamped metal tag often located on the firewall structure of an automobile. The metal tag may having visual markings include, for example, a unique serial number, date of manufacture, plant of manufacture, engine code, and other visual identification markings inherent to a particular the model, make, and options of the particular automobile. Not unlike a collectable coin that possesses visual markings for authentication and identification purposes, a 1970 Pontiac Trans Am Firebird automobile, for example, also possesses visual markings that may be utilized for authentication and identification of the unique appearance characteristics of a particular automobile. For example, unique appearance characteristics for a 1970 Pontiac Trans Am Firebird, may include, for example, an identification tag (ID) that includes a unique serial number, a stamped or etched unique engine code/serial number (often located on the engine block), and a stamped or etched unique transmission code/serial number (located on the transmission housing). Other visual markings, may include, for example, the odometer device displaying the mileage reading of the automobile, exterior paint characteristics, paint blemishes, chips, abrasions, scratches, interior component visual markings, and other unique appearance characteristics inherent to that particular collectable automobile or collectable object of interest.

FIG. 4 shows a right front perspective, exploded view of a data storage device including tamper resistant visual markings of an a collectable object as used in the present invention (discussed in FIG. 3). Upon assembly, non-volatile electronic data storage device 29 is provided with tamper resistant visual markings 23 that are associative with the visual markings of at least one collectable (as shown and discussed in FIG. 3), and is detached from the collectable object (shown in FIG. 1). Data storage device holder 20 includes tamper resistant visual markings 23 (shown in an exploded unassembled view) upon assembly with data storage device 29.

Data storage device holder 20 may be comprised of data storage device 29, a label 27 that provides a method for displaying visual markings 23 and 25 in a tamper resistant method, and a clear protective housing that is assembled together as shown with upper housing 21 and lower housing 31. Tamper resistant visual markings 23 are associative with the visual markings of the corresponding detached collectable object 11, or a holder that houses collectable object 11 (shown in FIG. 3) so as to provide association of the data storage device with the collectable object. Visual marking 25, for example, may include a corresponding barcode 25 in FIG. 2, and shown as barcode 9 in FIG. 3.

Tamper resistant visual markings may be provided for by means of a tamper resistant holder that houses data storage device 29, at least in part, and including a label 27 with tamper resistant visual markings 23 that are associative with a collectable object. As shown in FIG. 4, holder 20 may be comprised of an upper housing 21, and a lower housing 31 that are formed to enclose and protect label 27, visual markings 23, barcode 25, and data storage device 29. The holder may be made of a clear plastic, such as acrylic, and may be designed to be tamper resistant upon assembly that would make it difficult for a user to disassemble the holder once it has been assembled. This may be accomplished, for example, by a method that securely bonds upper housing 21 and lower housing 31 together, such as ultrasonic welding of the plastic mating surfaces during an assembly process. In this example, Label 27 provides a tamper resistant means for displaying associative visual markings of collectable object 11 (shown in FIG. 1), and may include collectable object descriptors, such as the date, the denomination, and a certification grade of the associative collectable object. Within the scope of the present, many other methods may be utilized to promote tamper resistance.

Data storage device 29, is shown as a USB Flash Drive, which is illustrated as only an example of an electronic non-volatile data storage device for use in the present invention because of it's compact size, and non-volatile memory (NVM) capability. However, many other examples of data storage devices could also be used such as a Flash Memory Card, PC Card, Memory Card, MultiMedia Card, Secure Digital Card, Memory Stick, xD-Picture Card and other compact sized, solid-state data storage devices. “Non-volatile” is well known in the industry as not having a power source integrated (on-board) with the data storage device itself, such as a battery. As the data storage device may be stored for many years, it is an objective of the present that it may be stored without concern of replacing a battery, or the potential adverse effects that may occur, over time, by any adverse chemical reactions that may occur with any attached battery or power source.

Data storage device 29 is configured to store at least one immutable digital image of at least one unique appearance characteristic of a collectable object, such as coin 11 shown in FIG. 3. “Immutable” shall mean data that is highly resistant to change or alteration. As such data storage device 29 is configured to have an immutable condition, at least in part, to deter a user from altering or erasing some or all images (and data) stored on data storage device 29. As such, data storage device 29, may be configured with a Read-Only-Memory (ROM), at least in part (such as an integrated circuit partition of the data storage device), or may be configured as a Write-Once-Read-Many (WORM) device that is immutable as a whole.

Unique appearance characteristics are commonly used by collectors and certification services for authentication and identification of a collectable object, such as coin 11, shown in FIG. 3. Data storage device 29 is configured to record and store at least one immutable digital image of at least one unique appearance characteristic of a collectable object and can be utilized for authentication and identification of the appearance characteristics of the collectable object.

Data storage device 29 is compatible with a standard computer system and does not require Internet-online operability for a user to view, evaluate, and compare digital images of the unique appearance characteristics of the associative (detached) collectable object. Data storage device 29 may comprise one or more detailed digital images of the appearance of the front (obverse), the back (reverse), and possibly the edge (reeding) of the coin. Certain images may be magnified to identify and focus on certain unique appearance characteristics of the collectable object, including very small details such as die-varieties (unique engraved dies used for minting the obverse and reverse of a coin), striking characteristics of the coin (related to the condition and striking pressure of the die), minute luster patterns created during the minting process, edge “reeding” characteristics (edge of a coin formed by a collar), minute abrasions or wear, and other minute identification appearance characteristics. Often times, collectable objects have more than one characteristic associated with the collectable object (such as coin 11 shown in FIG. 3), and data storage device 29 may include data of more than one characteristic of the collectable object. As such, data storage device 29 may include additional data, such as the date of minting, the production mintage, and a condition grade by a certification service of the collectable object. Additional information such as historical information including digital picture images of historical objects and/or persons that are associated with the collectable object may also be stored in data storage device 29. In some embodiments of the present invention, data storage device 29 may also contain one or more predetermined external database electronic links, such as the certification service's private network, and may be in the form of Internet Hyperlinks that can fetch (access) additional predetermined characteristics of the collectable coin, images, and other related data. Such “volatile” (changeable) data may include, for example, the current certification population and current valuation of the collectable object. Label 27 may further include a barcode 25, and when read by an appropriate barcode reader, may also provide predetermined characteristics of the associated collectable object by means of an appropriate barcode reader device.

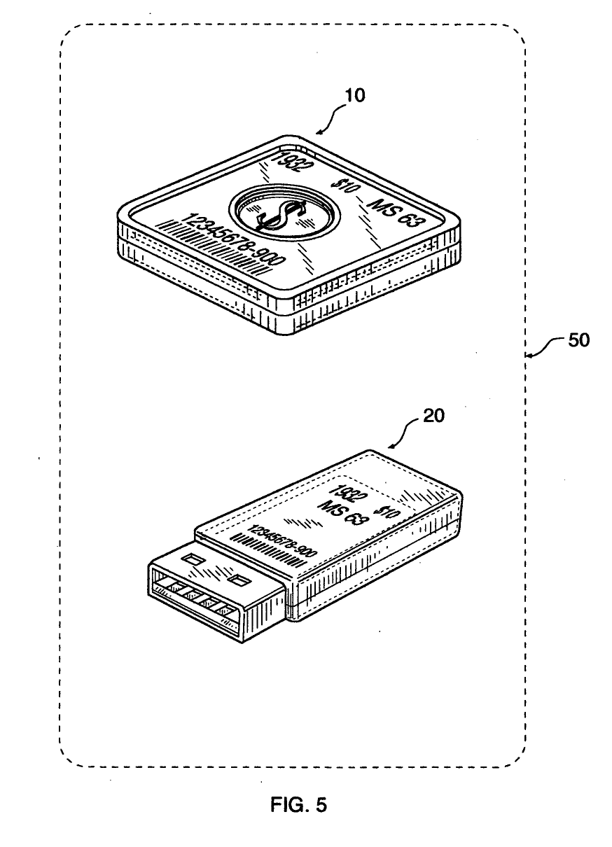

FIG. 5 shows a right front perspective view of an embodiment of the present invention including a collectable object having visual markings, housed in a holder having associative visual markings of the collectable object, and, a data storage device having associative visual markings of the holder that houses the collectable object. FIG. 5 shows an embodiment of the present invention 50 for an “associative data storage device for authentication of collectable objects,” and includes a non-volatile electronic data storage device (shown in assembled holder 20) for use in combination with at least one collectable object (shown in assembled holder 10). The non-volatile electronic data storage device is detached from the collectable object and electronically configured to store at least one immutable digital image of at least one unique appearance characteristic of a collectable object, such as a coin (shown in assembled holder 10). The data storage device is provided with tamper resistant visual markings (shown assembled with holder 20) that are associative with visual markings of the collectable object (shown assembled with holder 10), so as to provide association of data storage device with the collectable object. In FIG. 5, a collectable object (shown assembled with holder 10) is shown having a visual marking “$” that is associative with the visual markings seen on holder 10, such as inscription “$10,” and also on non-volatile electronic data storage device (shown assembled with holder 20).

The non-volatile electronic data storage device (shown assembled with holder 20) is compatible with a standard computer system for viewing at least one digital image of at least one unique appearance characteristic of a collectable, such as the collectable coin (shown assembled with holder 10).

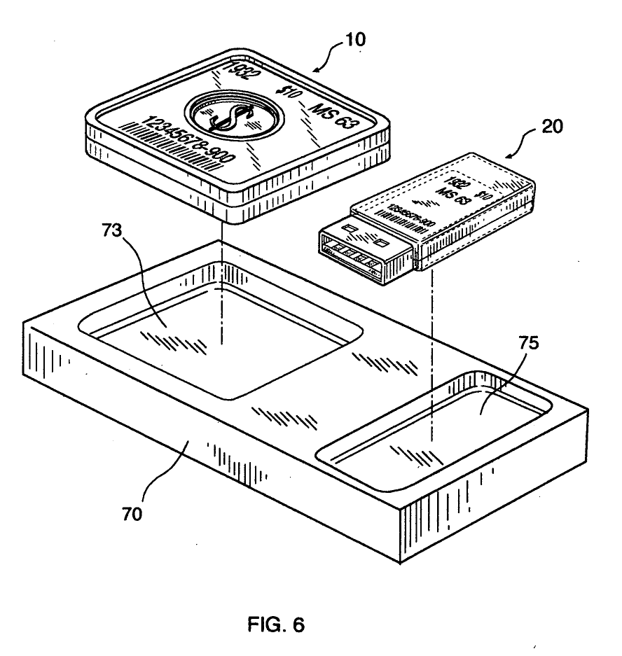

FIG. 6 shows a right front perspective view of a present invention including a data storage device for use in combination with a collectable object (housed in a holder), detachably stored in a container having cavity openings fitted for storing the data storage device and the collectable object (shown in a holder), as used in the present invention. FIG. 6 shows a right front perspective view of a present invention including a non-volatile electronic data storage device (shown assembled with holder 20) for use in combination with a collectable object, such as a coin (shown assembled with holder 10), being detachably stored in container 70. Container 70 has a formed cavity 75 fitted for storing the data storage device (shown assembled with holder 20) and a formed cavity 73 fitted for storing the collectable object (shown assembled with holder 10). The data storage device is compatible with a standard computer system for viewing at least one digital image of at least one unique appearance characteristic of a collectable object, such as a coin (shown assembled with holder 10).

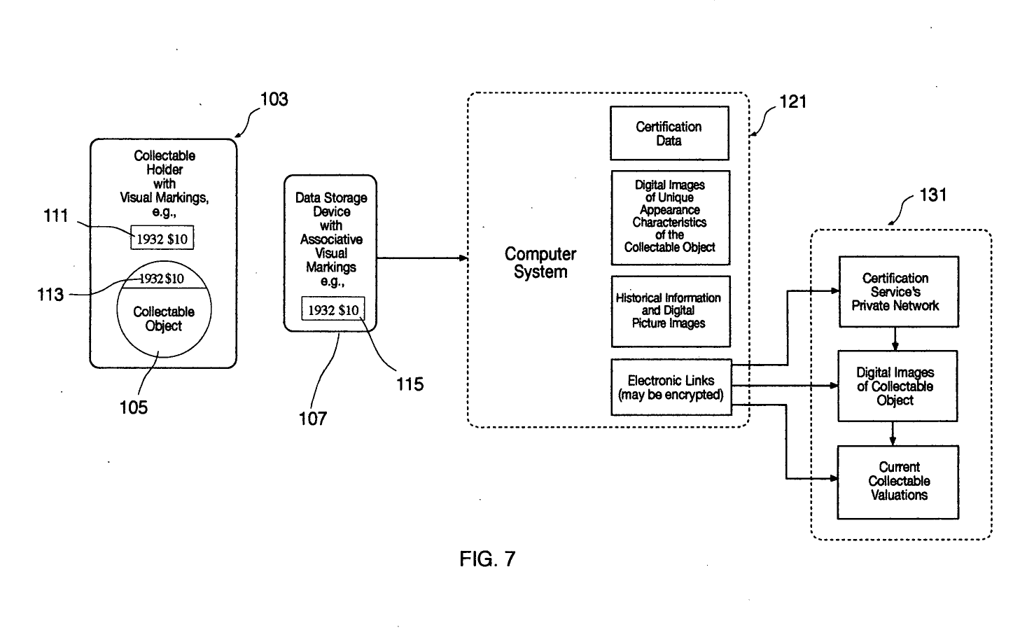

FIG. 7 shows a diagram of a present invention device for use in combination with a collectable object and a standard computer system. A non-volatile electronic data storage device 107 is used in combination with at least one collectable object 105 for authentication of collectable object 105. The non-volatile electronic data storage device 107 is detached from collectable object 105 and electronically configured to store at least one immutable digital image of at least one unique appearance characteristic of collectable object 105. Non-volatile electronic data storage device 107 is provided with tamper resistant visual markings 115 that are associative with visual markings 113 of collectable object 105 so as to provide association of the data storage device 107 with the collectable object 105. Collectable object 105 may be stored in a holder, such as holder 103. Non-volatile electronic data storage device 107 includes tamper resistant visual markings 115 associative with visual markings 113 of collectable object 105 that are also associative with tamper resistant visual markings 111 of holder 103.

The non-volatile electronic data storage device 107, such as a USB flash drive type data storage device, is compatible with a standard computer system 111 for a user to view one or more digital images of the unique appearance characteristics of collectable object 105 for authentication and identification of at least one unique appearance characteristic of collectable object 105. Non-volatile electronic data storage device 107 may also store historical information that may include digital picture images of historical objects and persons related to collectable object 105. Non-volatile electronic data storage device 107 may further include data of at least one characteristic of collectable object 105, such as certification data, and can viewed by a user on standard computer system 111. In some embodiments, non-volatile electronic data storage device 107 may further comprise at least one electronic link, such as a Hyperlink, that may fetch a predetermined remote database 113 that is related to coin 105 and accessed by a computer system 111. Predetermined remote database 113 may be a certification service's private network and may include additional comparative images of collectable object 105 and other information, such as volatile (changing information) and may include, for example, current certified populations and current valuations of collectable object 105. Remote database 113 may have an encrypted relationship with data storage device 107 in whole, or in part. It may include link encryption, end-to-end encryption, or file-system-level encryption, whereas only certain files are encrypted. Encryption is well known in the industry as a security protocol used to protect data in transit, by making it unreadable to anyone except those possessing special knowledge, usually referred to as a key. In this example of the present invention, data storage device 107 may comprise an encrypted key wherein the electronic link is an encrypted electronic link that enables the user of data storage device 107 to access remote database 113, or specific encrypted information of database 113 that is related to collectable object 105.

Although illustrative embodiments have been described herein in detail, it should be noted and will be appreciated by those skilled in the art that numerous variations may be made within the scope of this invention without departing from the principles and chief advantages of this invention. Unless otherwise specifically stated, the terms and expressions have been used herein as terms of description and not limitation.

Having thus described the invention, the following is claimed:

1. A non-volatile electronic data storage device for use in combination with at least one collectable object; said non-volatile electronic data storage device being detached from said collectable object and electronically configured to store at least one immutable digital image of at least one unique appearance characteristic of said at least one collectable object, said non-volatile electronic data storage being provided with tamper resistant visual markings associative with visual markings of said at least one collectable object so as to provide association of said non-volatile electronic data storage with said at least one collectable object, and, said non-volatile electronic data storage device being compatible with a standard computer system.

2. The non-volatile electronic data storage device of claim 1, wherein, said non-volatile electronic data storage device is a solid-state Flash Memory type data storage device.

3. The collectable object of claim 1, wherein said collectable object has more than one characteristic associated with said collectable object, and said non-volatile electronic data storage device includes data of said more than one characteristic of said at least one collectable object.

4. The non-volatile electronic data storage device of claim 1, wherein said tamper resistant visual markings associative with said at least one collectable object are also associative with tamper resistant visual markings of a holder that houses said at least one collectable object.

5. The non-volatile electronic data storage device of claim 1, wherein said non-volatile electronic data storage device is detachably stored in a container having a formed cavity fitted for storing said non-volatile electronic data storage device, and, said at least one collectable object is detachably stored in the same container having a formed cavity fitted for storing said at least one collectable object.

6. The holder of claim 4, wherein said tamper resistant markings of said holder that houses said at least one collectable object are associative with at least one corresponding tamper resistant visual marking of said non-volatile electronic data storage device.

7. The holder of claim 4, wherein said tamper resistant markings of said holder that houses said at least one collectable object includes a barcode that corresponds with said at least one tamper resistant visual marking of said non-volatile electronic data storage device.

8. The non-volatile electronic data storage device of claim 3, wherein said data storage device further comprises at least one digital picture image of an historical object or person related to said at least one collectable object.

9. The collectable object of claim 1, wherein said at least one collectible object is a coin.

10. A non-volatile electronic data storage device for use in combination with at least one collectable object; said non-volatile electronic data storage device being detached from said collectable object and electronically configured to store at least one immutable digital image of at least one unique appearance characteristic of said at least one collectable object, said non-volatile electronic data storage device being provided with tamper resistant visual markings associative with visual markings of said at least one collectable object so as to provide association of said non-volatile electronic data storage device with said at least one collectable object, and, said non-volatile electronic data storage device further comprising at least one immutable electronic link that fetches a predetermined remote database related to said at least one collectable object, and, said non-volatile electronic data storage device being compatible with a standard computer system.

11. The non-volatile electronic data storage device of claim 10, wherein, said non-volatile electronic data storage device is a solid-state Flash Memory type data storage device.

12. The collectable object of claim 10, wherein said collectable object has more than one characteristic associated with said collectable object, and said non-volatile electronic data storage device includes data of said more than one characteristic of said at least one collectable object.

13. The non-volatile electronic data storage device of claim 10, wherein said tamper resistant visual markings associative with said at least one collectable object are also associative with tamper resistant visual markings of a holder that houses said at least one collectable object.

14. The non-volatile electronic data storage device of claim 10, wherein said non-volatile electronic data storage device is detachably stored in a container having a formed cavity fitted for storing said non-volatile electronic data storage device, and, said at least one collectable object is detachably stored in the same container having a formed cavity fitted for storing said at least one collectable object.

15. The holder of claim 13, wherein said tamper resistant markings of said holder that houses said at least one collectable object are associative with at least one corresponding tamper resistant visual marking of said non-volatile electronic data storage device.

16. The holder of claim 13, wherein said tamper resistant markings of said holder that houses said at least one collectable object includes a barcode that corresponds with said at least one visual marking of said non-volatile electronic data storage device.

17. The non-volatile electronic data storage device of claim 12, wherein said non-volatile electronic data storage device further comprises at least one digital picture image of an historical object or person related to said at least one collectable object.

18. The electronic link of claim 10, wherein said electronic link fetches information related to said at least one collectable object.

19. The electronic link of claim 18, wherein said electronic link is an encrypted electronic link.

20. The encrypted electronic link of claim 19, wherein said electronic link provides a valuation of said at least one collectable object.
